(19) United States
(12) Patent Application Publication
(10) Pub. No.: US 2015/0081432 A1
(43) Pub. Date: Mar. 19, 2015

(54) TARGETED VENDOR OFFERS FOR TRAVELERS

(71) Applicant: MASTERCARD INTERNATIONAL INCORPORATED, Purchase, NY (US)

(72) Inventor: Kent Olof Niklas BERNTSSON, Rye, NY (US)

(73) Assignee: MASTERCARD INTERNATIONAL INCORPORATED, Purchase, NY (US)

(21) Appl. No.: 14/030,620

(22) Filed: Sep. 18, 2013

(51) Int. Cl. G06Q 30/02

(52) U.S. Cl. CPC G06Q 30/0255
USPC 705/14.53

(57) ABSTRACT

A system, method, and computer-readable storage medium target payment cardholders with offers based on their propensity to travel.

### BACKGROUND

1. Field of the Disclosure

Aspects of the disclosure relate in general to financial services. Aspects include an apparatus, system, method and computer-readable storage medium to target payment cardholders with offers based on their propensity to travel to a particular location.

2. Description of the Related Art

A payment card is a card that can be used by a cardholder and accepted by a merchant to make a payment for a purchase or in payment of some other obligation. Payment cards include credit cards, debit cards, charge cards, and Automated Teller Machine (ATM) cards.

Payment cards provide the clients of a financial institution (“cardholders”) with the ability to pay for goods and services without the inconvenience of using cash. For example, traditionally, whenever travelers leave home, they carried large amounts of cash to cover journey expenditures, such as transportation, lodging, and food. Payment cards eliminate the need for carrying large amounts of currency. Moreover, in international travel situations, payment cards obviate the hassle of changing currency.

In addition to currency issues, travelers have other problems. When visiting unknown places, travelers are often relegated to learning about sites from guide books, word-of-mouth, or recommendations by previous visitors. These sources of information are often outdated and untimely. Consequently, travelers will miss unique local opportunities at the visited location.

### SUMMARY

Embodiments include a system, device, method and computer-readable medium to target payment cardholders with offers based on their propensity to travel.

In one embodiment, a system comprises a network interface and a processor. The network interface is configured to receive transaction data from a merchant bank. The transaction data includes a cardholder identifier associated with a customer, addenda for the transaction data, and a vendor. The processor is configured to extract travel information from the addenda. The travel information includes an anticipated date of travel and an anticipated location. The processor matches the travel information with a travel offer stored in a vendor offer database, resulting in a matched travel offer. The network interface is further configured to transmit to the customer the matched travel offer.

### BRIEF DESCRIPTION OF THE DRAWINGS

FIG. 1 is a block diagram illustrating a system to target payment cardholders with offers based on their propensity to travel to a particular location.

FIG. 2 is an expanded block diagram of an exemplary embodiment of a server architecture of a payment processor embodiment configured to target payment cardholders with offers based on their propensity to travel to a particular location.

FIG. 3 illustrates a method to target payment cardholders with offers based on their propensity to travel to a particular location.

### DETAILED DESCRIPTION

One aspect of the disclosure includes the realization that anticipated cardholder travel data may be incorporated as a factor to target payment cardholders with offers based on their propensity to travel to a particular location. Further, a system and method may parse anticipated cardholder travel from cardholder travel purchases. In such a system, the payment card network combines the anticipated travel into a travel database.

While some of the embodiments described herein are applied to a cross-border context, it is understood by those familiar with the art that the concepts, apparatus, system and methods described herein may also be applicable to domestic travel that is far from a cardholder's usual area of residence.

The systems and processes are not limited to the specific embodiments described herein. In addition, components of each system and each process can be practiced independently and separately from other components and processes described herein. Each component and process also can be used in combination with other assembly packages and processes.

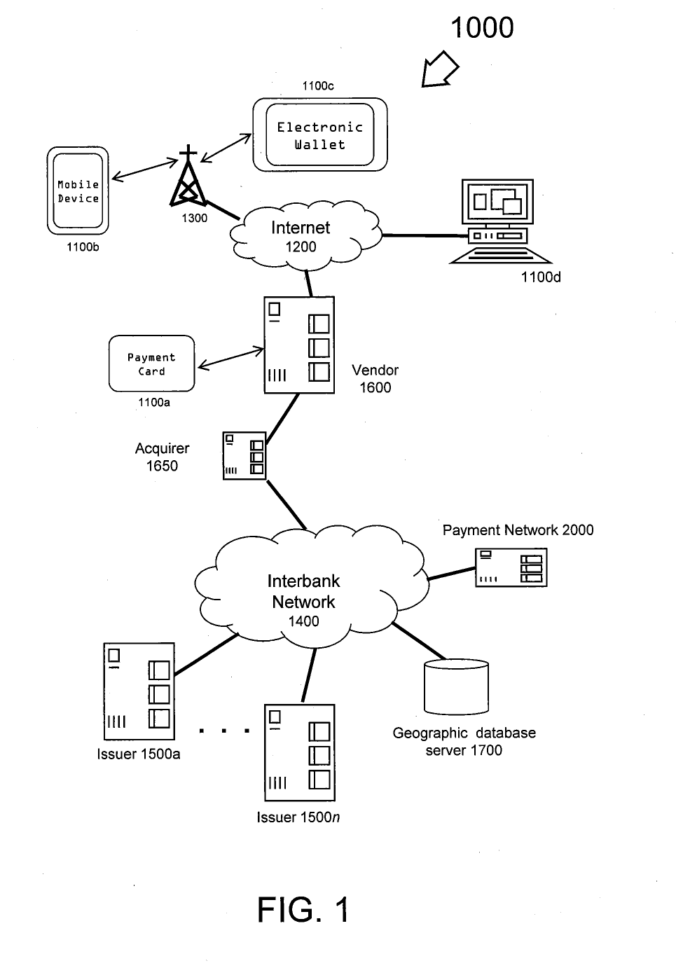

FIG. 1 is a block diagram 1000 illustrating a financial transaction using a payment card payment system configured to target payment cardholders with offers based on their propensity to travel to a particular location. The present disclosure is related to a payment card payment system, such as a credit card payment system using the MasterCard® interchange, Cirrus® network, or Maestro®. The MasterCard interchange is a proprietary communications standard promulgated by MasterCard International Incorporated for the exchange of financial transaction data between financial institutions that are customers of MasterCard International Incorporated. Cirrus is a worldwide interbank network 1400 operated by MasterCard International Incorporated linking debit and payment cards to a network of ATMs throughout the world. Maestro is a multi-national debit card service owned by MasterCard International Incorporated.

In a financial payment system, a financial institution called the “issuer” 1500 issues a payment card to a consumer, who uses payment card 1100a to tender payment for a cross-border purchase from a vendor 1600 or withdraw cash from an Automated Teller Machine. In addition to payment cards 1100a, it is understood by those familiar with the art that the process herein applies equally to mobile device 1100b (such as key fobs, mobile phones, tablet computers, and the like), electronic wallets 1100c, or computers 1100d, connected to vendor 1600 via a mobile telephone network 1300 or the internet 1200.

In this example, a cardholder presents the payment card to a point-of-sale device at a vendor 1600. The vendor 1600 is affiliated with a financial institution. This financial institution is usually called the “merchant bank,” “acquiring bank,” “acquirer bank” or “acquirer” 1650. When a payment card 1100a is tendered at a vendor 1600, the vendor 1600 electronically requests authorization from the acquirer 1650 for the amount of the purchase. The request is performed electronically with the consumer's account information from the magnetic stripe on the payment card or via a computer chip imbedded within the card 1100a. The account information and transaction information are forwarded to transaction processing computers of the acquirer 1650. Alternatively, an acquirer 1650 may authorize a third party to perform transaction processing on its behalf. In this case, the vendor 1600 will be configured to communicate with the third party. Such a third party is usually called a “merchant processor” or an “acquiring processor.”

In instances where a cardholder is purchasing a travel-related service, such as plane, train, bus, or other travel tickets, hotels, rental-cars and the like, the transaction information contains addenda describing the purchase. For example, suppose the cardholder is purchasing plane tickets from New York City to San Francisco, Calif. The addenda may include itinerary information such as dates of travel, the airline and flight number, and origination/destination airport codes for the flights.

Using a payment network 2000, the computers of the acquirer 1650 or the merchant processor will communicate via an interbank network 1400 with the computers of the issuer bank 1500 to determine whether the consumer's account is in good standing and whether the transaction is likely to be fraudulent.

When a request for authorization is accepted, the available credit balance of cardholder's account is decreased.

After a transaction is captured, the transaction is settled between the vendor 1600, the acquirer 1650, and the issuer 1500. As described herein, the term “payment card” includes cards such as credit cards, charge cards, and debit cards, but also includes any other devices that may hold payment account information, such as mobile phones, personal digital assistants (PDAs), cloud-based accounts, cashless payment devices/methods, and key fobs.

After the financial transaction has occurred, payment network 2000 analyzes anticipated travel information derived from the transaction addenda that has been corrected by a geographic database server 1700, and makes a determination as to the propensity of an individual to travel based thereon. An example geographic database server 1700 is a Global Distribution Systems database. In yet other embodiments, a credit reporting agency, payment card issuer 1500, geographic database server 1700 and/or payment network 2000 may track anticipated travel information. Based on these propensity to travel determinations by payment network 2000, a search is performed against a merchant offer database comparing the location and dates of travel against offers stored within the merchant offer database. Matched vendor offers are transmitted to the cardholder.

In yet other embodiments of the disclosure, payment network 2000 is further able to categorize and match offers based on a cardholder's spend-level, spending-pattern, or status. In some embodiments, the offers may also match offers based on whether the payment card is a personal payment card or a business payment card.

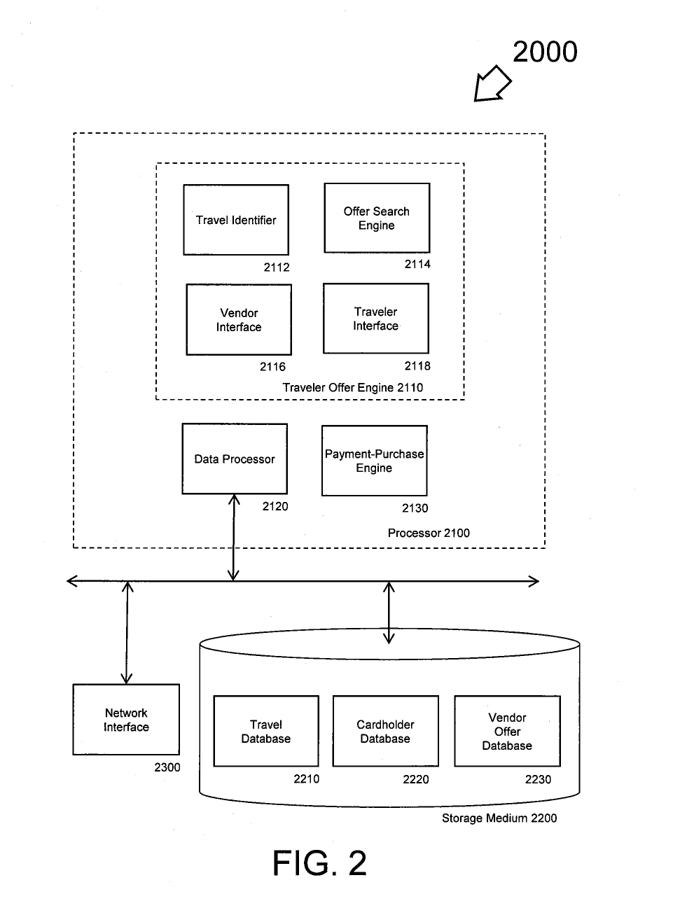

Embodiments will now be disclosed with reference to a block diagram of an exemplary payment server of FIG. 2, configured to target payment cardholders with offers based on their propensity to travel to a particular location, constructed and operative in accordance with an embodiment of the present disclosure. It is understood by those familiar with the art, that a payment server may exist at an issuer 1500, as a geographic database server 1700, at a credit reporting agency, or at a payment network 2000.

Payment server may run a multi-tasking operating system (OS) and include at least one processor or central processing unit (CPU) 2100, a non-transitory computer-readable storage medium 2200, and a network interface 2300.

Processor 2100 may be any central processing unit, microprocessor, micro-controller, computational device or circuit known in the art. It is understood that processor 2100 may temporarily store data and instructions in a Random Access Memory (RAM) (not shown), as is known in the art.

As shown in FIG. 2, processor 2100 is functionally comprised of a travel offer engine 2110, a payment-purchase engine 2130, and a data processor 2120.

Data processor 2120 interfaces with storage media 2200 and network interface 2300. The data processor 2120 enables processor 2100 to locate data on, read data from, and writes data to, these components.

Payment-purchase engine 2130 performs payment and purchase transactions, and may do so in conjunction with travel offer engine 2110.

Travel offer engine 2110 is the structure that enables targeting payment cardholders with offers based on their propensity to travel to a particular location, and may further comprise: a travel identifier 2112, an offer search engine 2114, a vendor interface 2116, and traveler interface 2118.

Travel identifier 2112 analyzes the addenda of financial transactions to identify anticipated future travel by a cardholder.

Offer search engine 2114 is a structure configured to match anticipated travel with vendor offers stored in a vendor offer database.

Vendor interface 2116 is an application program interface (API) that facilitates vendors 1600 to store vendor offers into a vendor offer database.

Traveler interface 2118 is the application interface to facilitate electronic communication with the traveler cardholder. In some embodiments, traveler interface 2118 may telephone, e-mail, or text message the traveler's mobile device 1100b. In other embodiments, traveler interface 2118 may work in conjunction with an application (“app”) running on the traveler's mobile device 1100b. In other embodiments, traveler interface 2118 facilitates communication via the World Wide Web (WWW or “web”).

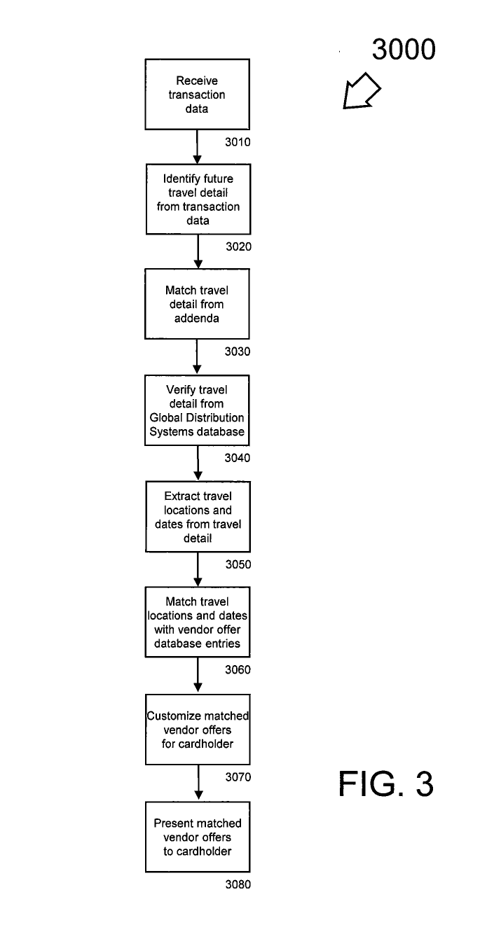

The functionality of the travel offer engine 2110 structures is elaborated in greater detail in FIG. 3.

These structures may be implemented as hardware, firmware, or software encoded on a computer readable medium, such as storage media 2200. Further details of these components are described with their relation to method embodiments below.

Non-transitory computer-readable storage media 2200 may be a conventional read/write memory such as a magnetic disk drive, floppy disk drive, optical drive, compact-disk read-only-memory (CD-ROM) drive, digital versatile disk (DVD) drive, high definition digital versatile disk (HD-DVD) drive, Blu-ray disc drive, magneto-optical drive, optical drive, flash memory, memory stick, transistor-based memory, magnetic tape or other computer-readable memory device as is known in the art for storing and retrieving data. In some embodiments, computer-readable storage media 2200 may be remotely located from processor 2100, and be connected to processor 2100 via a network such as a local area network (LAN), a wide area network (WAN), or the Internet.

In addition, as shown in FIG. 2, storage media 2200 may also contain a travel database 2210, a cardholder database 2220, and a vendor offer database 2230. Travel offer engine 2110 may store data related to cardholder payment credit, debit, or charge information in a cardholder database 2220; in some embodiments, cardholder database 2220 may also cardholder telephone numbers and electronic mail addresses as well as a cardholder spending profile. A cardholder spending profile may be a history of expenditures made by a cardholder, a model of the cardholder spending pattern, or other method of profiling cardholder expenditures. Additionally, travel database 2210 may store data related to anticipated cardholder travel. Vendor offer database 2230 stores offers uploaded by vendor 1600. Vendor offer database entries contain the details of the offer, the offer time period, and a geographic location of the offer. It is understood by those familiar with the art that one or more of these databases 2210-2230 may be combined in a myriad of combinations.

Network interface 2300 may be any data port as is known in the art for interfacing, communicating or transferring data across a computer network, examples of such networks include Transmission Control Protocol/Internet Protocol (TCP/IP), Ethernet, Fiber Distributed Data Interface (FDDI), token bus, or token ring networks. Network interface 2300 allows payment server to communicate with merchant 1100 and issuer 1200.

We now turn our attention to method or process embodiments of the present disclosure, FIG. 3. It is understood by those known in the art that instructions for such method embodiments may be stored on their respective computer-readable memory and executed by their respective processors. It is understood by those skilled in the art that other equivalent implementations can exist without departing from the spirit or claims of the invention.

Embodiments create a spend-derived profile to anticipate cardholder travel to a destination. FIG. 3 illustrates a process 3000 in which payment cardholders are targeted with offers based on their propensity to travel to a particular location, constructed and operative in accordance with an embodiment of the present disclosure. It is understood by those familiar with the art that process 3000 may be a non-real time clearing process, but in alternate embodiments may be a real time process. Conventionally, a clearing process is a non-real time process. Furthermore, it is understood that process 3000 or variations thereof may occur at an issuer 1500, at a geographic database server 1700, at a credit reporting agency, or at a payment network 2000. For the sake of example, this disclosure will discuss a payment network 2000 embodiment.

At block 3010, payment network 2000 receives transaction data from a merchant bank. The transaction data is received electronically via a network interface, and may be part of data from many transactions received via a batch process.

In non-payment network 2000, embodiments, the transaction data may be received at an issuer 1500, a geographic database server 1700, or a credit reporting agency from a vendor 1600 or payment network 2000.

At block 3020, the travel identifier 2112 of the travel offer engine 2110 analyzes the batch-received transactions in order to identify future travel detail from transaction data.

At block 3030, travel identifier 2112 determines whether the travel-related transaction has correctly provided traveler itinerary information encoded within addenda associated with the travel-related transaction. These addenda messages are populated by travel providers (such as airlines) and travel agencies at the time payment for a booking is made. Such itinerary information may include the name of the traveler, the travel destination/departure points, and date of travel.

In some instances, the addenda are incomplete. In such instances, travel identifier 2112 verifies the travel itinerary information against a geographic database server 1700, block 3040. Such a database includes flight details, and pricing on many flights. As part of the verification process, the addenda are corrected and travel details are added, if necessary.

At block 3050, the transaction addenda data is parsed to determine itinerary information from the travel-related transaction dates, times, and location from travel-related transaction. The travel-related transaction data may relate to any travel-related data known in the art, such as a purchase or reservation of airline tickets, train tickets, bus tickets, hotel reservations or payments, rental car reservations, cruise tickets or reservations, or experience-ticket purchases (such as theater or show tickets).

At block 3060, the anticipated travel is matched against vendor offers stored within vendor database 2230 by offer search engine 2114. For example, if cardholder Denise purchases a round-trip airfare from Los Angeles to Vienna, Austria, departing on January 25^{th}, and returning on February 14^{th}, then a search is performed for vendor offers within the vendor database 2230 that apply for Vienna, Austria within the January 25^{th} through February 14^{th} time period. Similarly, if cardholder Denise purchases opera tickets at the Salzburg Opera on January 27^{th}, a search for vendor offers in Salzburg, Austria on that date would be performed. In some embodiments, the search may adjust or extrapolate location information to proximate locations, based on city, metropolitan area, county, state, province or country. In other embodiments, the search may adjust or extrapolate location information based on distance from the anticipated travel. For example, vendor offers within 1, 2, 5, 10, or 20 mile radius of the anticipated travel location may be searched.

Note that in some embodiments, the search may also adjust the time period parameters to be within a day, several days, weeks, or months around the anticipated travel time period. Using the above example, such an embodiment may search for vendor offers that apply for Vienna, Austria, within January and February.

When no traveler information is listed in the addenda, the cardholder may be assumed to be the traveler.

At block 3070, the matched vendor offer entries are customized for the cardholder. In many situations, there may be many matched vendor offers that match a cardholder's anticipated travel plans. This may especially be the case when a cardholder travels to a popular high-population-density area with many vendors. For example, suppose the cardholder is visiting New York City, where potentially tens-of-thousands of vendors may populate the vendor offer database 2230. In such situations, there may be too many matched vendor offers available, which may overwhelm a cardholder. At block 3070, offer search engine 2114 further filter and customizes the list of matched vendor offer entries to a manageable number. In some embodiments, the number of matched entries may be selected by the cardholder, predetermined by the system, or both.

In some embodiments, offer search engine 2114 may filter the matched vendor offer entries with a further geographic location reduction.

In embodiments where cardholder database 2220 stores a cardholder spending profile, offer search engine 2114 may compare the matched vendor offers with the cardholder spending profile, to determine which offers a cardholder would most likely use or have greatest interest, and present those matched vendor offers. Based on purchase history, traveler offer engine 2110 may create profiles for each cardholder. For example, if a cardholder has a high propensity to spend at sports stores, traveler offer engine 2110 may create a profile called something like “Sport Lovers.” Based on this profile, traveler offer engine 2110 knows that a sport store related offer may be more suitable than some other offer.

At block 3080, the traveler offer engine 2110 presents the matched vendor offers to the customer, including details of the goods/services in the offer, offer vendor or location, and any offer time limit (or offer time period). Matched vendor offers may include purchase requirements, deal (participating) locations, date of expiration, and payment details (e.g., must use payment card). In some embodiments, the matched vendor offers may include an identifier identifying the customer so that their use of the matched vendor offer may be tracked. Additionally, in some embodiments matched vendor offers have an associated unique identifier; in such embodiments, the unique identifier may be used to verify the validity of the matched vendor offers, and track the purchase and redemption of the matched vendor offers. Any or all of the above-described information may be stored into the vendor offer database 2230.

Matched vendor offers may be presented in a number of different ways.

In some real-time embodiments, presentation of the matched vendor offers happens at the time and point of purchase. In such an embodiment, the traveler offer engine 2110 electronically transmits the matched vendor offers as a “push” message to vendor 1600 via acquirer 1650. In some instances, the vendor travel offer may be presented on the cardholder's receipt, for example. In such an embodiment, the push message may be transmitted as a field in the approval transaction message. In an on-line purchase embodiment, the matched vendor offer may presented by the vendor 1600 as part of a confirmation electronic mail or presented on a purchase confirmation screen on the World-Wide-Web. For example, when an airline ticket is purchased on-line by a cardholder, the vendor 1600 may send the matched vendor offer in a confirmation e-mail message saying that the purchase is being processed, or along with the electronic ticket.

In other embodiments, the matched vendor offers are electronically sent to the traveler cardholder via issuer 1500. In such an embodiment, the traveler offer engine 2110 electronically transmits the matched vendor offers as a message to issuer 1500, which in turn conveys the matched vendor offers to the issuer. For example, the matched vendor offer may be presented on the cardholder's payment card statement.

In yet other embodiments, the matched vendor offers are electronically transmitted directly to the cardholder via telephone, e-mail, text message the traveler's mobile device 1100b, or via an application running on the traveler's mobile device 1100b.

It is understood by those familiar with the art that the system described herein may be implemented in hardware, firmware, or software encoded on a non-transitory computer-readable storage medium.

The previous description of the embodiments is provided to enable any person skilled in the art to practice the disclosure. The various modifications to these embodiments will be readily apparent to those skilled in the art, and the generic principles defined herein may be applied to other embodiments without the use of inventive faculty. Thus, the present disclosure is not intended to be limited to the embodiments shown herein, but is to be accorded the widest scope consistent with the principles and novel features disclosed herein.

What is claimed is:

1. A method comprising:
receiving, via a network interface, payment card transaction data from a merchant bank, the transaction data including a cardholder identifier associated with a customer, addenda for the transaction data, and a vendor;
extracting, with a processor, travel information from the addenda, the travel information including an anticipated date of travel and an anticipated location;
matching, with the processor, travel information with a travel offer stored in a vendor offer database, resulting in a matched travel offer;
transmitting to the customer, via the network interface, the matched travel offer.

2. The processing method of claim 1, wherein the transmitting to the customer occurs via a message sent to the merchant bank.

3. The processing method of claim 2, wherein merchant bank further forwards the message to the customer via the vendor.

4. The processing method of claim 3, wherein the matched travel offer is printed on a transaction receipt.

5. The processing method of claim 1, wherein the transmitting to the customer occurs via a message sent to an issuer of a payment card used in a transaction associated with payment card transaction data.

6. The processing method of claim 5, wherein the matched travel offer is printed on a payment card statement.

7. The processing method of claim 1, wherein the transmitting to the customer occurs via an automated telephone message, e-mail, or text message.

8. A system comprising:
a network interface configured to receive transaction data from a merchant bank, the transaction data including a cardholder identifier associated with a customer, addenda for the transaction data, and a vendor;
a processor configured to extract travel information from the addenda, the travel information including an anticipated date of travel and an anticipated location, the processor further configured to match travel information with a travel offer stored in a vendor offer database, resulting in a matched travel offer;
wherein the network interface is further configured to transmit to the customer the matched travel offer.

9. The system of claim 8, wherein the transmitting to the customer occurs via a message sent to the merchant bank.

10. The system of claim 9, wherein merchant bank further forwards the message to the customer via the vendor.

11. The system of claim 10, wherein the matched travel offer is printed on a transaction receipt.

12. The system of claim 8, wherein the transmitting to the customer occurs via a message sent to an issuer of a payment card used in a transaction associated with payment card transaction data.

13. The system of claim 12, wherein the matched travel offer is printed on a payment card statement.

14. The system of claim 8, wherein the transmitting to the customer occurs via an automated telephone message, e-mail, or text message.

15. A non-transitory computer readable medium encoded with data and instructions, when executed by a computing device the instructions causing the computing device to:
receive, via a network interface, payment card transaction data from a merchant bank, the transaction data including a cardholder identifier associated with a customer, addenda for the transaction data, and a vendor;
extract, with a processor, travel information from the addenda, the travel information including an anticipated date of travel and an anticipated location;
match, with the processor, travel information with a travel offer stored in a vendor offer database, resulting in a matched travel offer;
transmit to the customer, via the network interface, the matched travel offer.

16. The non-transitory computer readable medium of claim 15, wherein the transmitting to the customer occurs via a message sent to the merchant bank.

17. The non-transitory computer readable medium of claim 16, wherein merchant bank further forwards the message to the customer via the vendor.

18. The non-transitory computer readable medium of claim 17, wherein the matched travel offer is printed on a transaction receipt.

19. The non-transitory computer readable medium of claim 15, wherein the transmitting to the customer occurs via a message sent to an issuer of a payment card used in a transaction associated with payment card transaction data.

20. The non-transitory computer readable medium of claim 19, wherein the matched travel offer is printed on a payment card statement.

21. The non-transitory computer readable medium of claim 15, wherein the transmitting to the customer occurs via an automated telephone message, e-mail, or text message.
